(19) United States
(12) Patent Application Publication
(10) Pub. No.: US 2026/0264073 A1
(43) Pub. Date: Sep. 10, 2026

(54) IMPROVED MICROFLUIDIC ASSEMBLY

(71) Applicant: MIDIAGNOSTICS NV, Heverlee (BE)

(72) Inventors: Tom CLAES, Heverlee (BE); Thomas WILLSHARE, Heverlee (BE); Marie-Noelle GRIS, Heverlee (BE); Agnese PIOVESAN, Heverlee (BE)

(73) Assignee: MIDIAGNOSTICS NV, Heverlee (BE)

(21) Appl. No.: 19/165,372

(22) PCT Filed: Mar. 15, 2024
(86) PCT No.: PCT/EP2024/056972

§ 371 Date: Sep. 15, 2025

(30) Foreign Application Priority Data
Mar. 16, 2023 (EP) 23162273.9

(51) Int. Cl. B01L 3/00

(52) U.S. Cl. CPC B01L 3/502707; B01L 2200/0684; B01L 2300/046; B01L 2300/0816; B01L 2300/0848; B01L 2300/0883; B01L 2300/12; B01L 2300/165

(57) ABSTRACT

The field of the invention relates to microfluidic assemblies, and in particular to microfluidic assemblies for guiding a liquid to a silicon chip for performing a diagnostic test. In particular, a microfluidic assembly is provided with a mechanical arrangement for generating a driving pressure for assisting the liquid provided into the microfluidic assembly by a user to enter into the sample processing path patterned in the microfluidic silicon chip. The present invention also provides a use of a microfluidic assembly for performing one or more diagnostic tests, and a kit of parts comprising a microfluidic assembly.

### TECHNICAL FIELD

The field of the invention relates to microfluidic assemblies, and in particular to microfluidic assemblies for guiding a liquid to a silicon chip for performing a diagnostic test. In particular, a microfluidic assembly is provided with a mechanical arrangement for generating a driving pressure for assisting the liquid provided into the microfluidic assembly by a user to enter into the sample processing path patterned in the microfluidic silicon chip. The present invention also provides a use of a microfluidic assembly for performing one or more diagnostic tests, and a kit of parts comprising a microfluidic assembly.

### BACKGROUND

Biological samples derived from living cells comprise a multitude of different substances, such as proteins, lipids, carbohydrates, nucleic acids, and other small molecule metabolites. Biochemical and biomedical analysis of these samples can therefore provide valuable medical information and can help in diagnosing conditions, diseases, or illnesses in individuals.

An ongoing trend in analysing biological samples, is to perform as many different biochemical assays as possible with a limited amount of a sample volume. For this reason, many analysis apparatuses and instruments make use of microfluidics-based systems, which allow the use of extremely low, i.e., micro- and nanolitre-scale, reaction volumes of liquid samples. These microfluidics-based systems typically comprise microchannel reactors, such as microfluidic chips, for analysing the liquid biological samples.

Because the microchannel reactors are typically very small in size, most microfluidics-based systems also comprise an assembly for housing the microchannel reactors or microfluidic chips. These assemblies are miniaturized devices which aim to promote easier handling of the microfluidic reactors. For example, most assemblies comprise a sample inlet and a system of microfluidic channels to guide sample liquids towards the microchannel reactors. This prevents direct loading of the sample onto the chip or reactor so that the risk of overflowing and contamination of the microchannel reactor is reduced.

However, because microfluidic-based systems are being miniaturized even more in order to further decrease the required sample reaction volumes and to perform relevant analyses faster, it has become increasingly difficult to design assemblies that are compatible with these increased miniaturized systems. One challenge lies in the increased risk of contamination of the microfluidic chip or the reader to which a contaminated assembly (e.g. stained with a spillage made during loading the chip) is inserted. This problem is becoming more pronounced as the systems progressively become more miniaturized, which results in the sample-accepting inlet and the zone for reading the output from the microfluidic chip in the reader getting positioned closer to each other. Another challenge associated with the decreased size of the microfluidic-based systems is inaccurate sample loading into the assembly by the user because the dimensions of the sample inlet also need to be reduced. Further, decreasing the sample volumes to be analysed by microfluidic-based systems requires the further miniaturization of the microfluidic channels in the assembly, which can strongly affect the flow of the sample liquid. Finally, there in the increased risk of liquid flows stopping at the interface of two different fluidic components, such as channels made from different materials.

Thus, there is a need for providing microfluidic assemblies which can accept limited volumes of liquid samples, and which still allow for easy handling for the user of microfluidic-based systems.

It is therefore an object of the present invention to provide a microfluidic assembly for guiding a liquid to a chip for performing a diagnostic assay that overcomes the above-listed and other challenges.

### SUMMARY

This object is achieved, in a first aspect, by provision of a microfluidic assembly for guiding a liquid to a silicon chip comprising a continuous groove for performing a diagnostic test, the disclosed herein assembly comprising a housing structure for housing the silicon chip, a sample well for receiving the liquid, a first outlet port adapted to guide the liquid to the continuous groove of the silicon chip when housed, a feeder channel extending from the sample well to the outlet port; and a closing lid comprising a protruding part adapted to close the sample well; characterized in that the volume of the protruding part is adapted to the volume of the feeder channel such that when closing the sample well after filling it with the liquid, a driving pressure is created for assisting the liquid to pass from the outlet port to the continuous groove of the silicon chip when housed. Consequently, provided herein is a microfluidic assembly wherein the volume of the protruding part of the closing lid of the assembly is adapted to the volume of the feeder channel such that when closing the sample well after providing the liquid thereto, a driving pressure is created that is sufficient to provide an additional push for assisting the liquid present in the feeder channel to pass from the first outlet port to the continuous groove of the silicon chip, thereby initialling a jump of a least a portion of the liquid into the continuous groove, which allows to fill said groove of the chip with the liquid.

In a preferred embodiment the assembly comprises the silicon chip. In other words, advantageously, the disclosed herein microfluidic assembly comprises the silicon chip housed within or connected to the housing structure, preferably wherein the silicon chip is fixed to the housing structure, for example fixedly positioned or fixedly attached with respect of the housing structure. In case of the silicon chip being fixedly positioned within or fixedly attached to the housing structure, the continuous groove comprised by the silicon chip is aligned to be in fluidic continuity with the feeder channel through the first outlet port. Liquid received in the sample well may initially be actuated by passive capillary forces or capillary pressures to flow into the feeder channel. Further assistance, such as the creation of the driving pressure resulting from closing of the sample well aims to ensure that the liquid filling the feeder channel receives an additional push to initiate a jump of at least the distal (with respect to the sample well) portion of said liquid through the outlet port into the continuous groove of the silicon chip. The inventors have observed that depending on the rheological properties of certain liquids and their interplay with surfaces of different materials (e.g. relating to wetting ability and capillary action-related movement) that make the feeder channel of the housing structure and the continuous groove within the silicon chip, the ability to initiate such jump is frequently a limiting factor for smooth and uniform guiding the liquid into the groove which helps in filling of the groove with said liquid for performing the diagnostic test-related reaction on the silicon chip.

By adjustment of the geometric characteristics of the sample well and the protruding part, the creation of the driving pressure can be designed such to ensure that liquid samples having certain physical (e.g. viscosity, tendency to create bubbles or potentially-clogging aggregates etc.) and rheological properties, which would otherwise oppose the primarily-capillary movement and transfer between the feeder channel and the groove, will receive the necessary push to make the initial jump between channels made from two distinct materials (i.e. the silicon of the chip and e.g. plastic of the feeder channel of the housing structure) and therefore will be smoothly guided into the groove of the silicon chip. Also, push assisted pressure ensures liquid flow in case of subtle misalignment or partial overlap at the interface of the channels.

In addition to the above, the inventors have found that the microfluidic assembly as disclosed herein further demonstrates at least one or more the following advantages:
Easier handling of the microfluidic assembly and more accurate sample loading by the user;
Reduced sample splashing when loading the sample liquid, and accordingly, less contamination on the surfaces of the assembly and in particular over the surface of the silicon chip and, hence, its corresponding processing and/or reading machine; and
Improved transfer of the sample liquid from the feeder channel toward the continuous groove of the silicon chip, in extreme cases allowing guiding into the silicon chip of liquids with challenging for nano-/micro-geometries rheological properties or rheological profiles.

In a further but related aspect, use of the disclosed herein microfluidic assembly is provided in diagnosis, in particular in performing a diagnostic test, for example on a liquid biological sample (e.g. blood, in particular blood of a diseased person e.g. suffering from sepsis, or mucus, etc.) or a pre-processed liquid biological sample, which liquid sample would otherwise be challenging or even impossible to be guided and loaded into minute continuous micro-or nanofluidic compartments patterned within a silicon chip for performing a diagnostic reaction.

These and other aspects of the invention, and their advantages are explained in continuation.

### DEFINITIONS

In the context of the presented herein microfluidic assembly and as generally used herein, the terms “microfluidic” and “nanofluidic” are used interchangeably and refer to systems and arrangements dealing with the behaviour, control, and manipulation of fluids that are geometrically constrained to millimetre, sub-millimetre, and even sub-micrometre-scale, e.g. nanometre-scale, in at least one or two dimensions (e.g. width and height of a channel or groove). Such small-volume fluids are moved, mixed, separated or otherwise processed at a (sub)micrometre scale requiring small size and low energy consumption. Nanofluidic systems include structures such as micro-pneumatic systems (pressure sources, liquid pumps, micro valves, etc.) and nanofluidic structures for the handling of micro, nano- and picolitre volumes (microfluidic grooves, etc.). Accordingly, terms “microfluidic assembly” and “fluidic assembly” and sometimes “nanofluidic assembly” are to be treated as synonyms.

As used herein, the terms “microfluidic assembly” and “nanofluidic assembly” are to be treated as synonyms and construed as relating to a multi-component liquid-handling device assembled from separately manufactured parts for accepting at least a sample liquid and/or, possibly, reagent liquids and/or housing liquid or solid reagents, and further guiding the sample liquid to a silicon chip, which chip is can be one of the parts of said assembly, and wherein said multi-component liquid-handling device is formed as a single object that can be transferred or moved as one fitting inside or outside of a larger instrument adapted to and/or suitable for accepting or connecting to such “microfluidic assembly”.

As used herein, the terms “silicon chip”, or simply “chip”, or sometimes “microfluidic chip”, “nanofluidic chip”, “nanofluidic processor” are to be treated synonymously and in accordance with its standard meaning within the field, construed as referring to a small physical device, at least partially made of silicon and frequently monolithic, which houses a patterned fluidic circuit represented as at least one groove patterned in the chip's body, wherein at least part of the groove is adapted for processing a liquid.

As used herein the term “groove” is to be understood as any functionally defined compartment of any geometrical shape within the chip of the nanofluidic assembly, defined by at least one wall and comprising the means necessary for performing the processing function which is attributed to this compartment, such as e.g. sample processing and/or analysis, e.g. by nucleic acid amplification e.g. by PCR. Usually, a silicon chip is patterned on at least one, usually one, of its two major surfaces. Consequently, as sometimes used herein, the surface of the silicon chip comprising the continuous groove will be referred to as the “patterned surface” or, possibly, “etched surface” (in case etching is a technique involved in patterning said surface of the chip). Analogously, the term “bottom surface of the chip” is to be understood as the closed or flat surface of the chip, which is opposite to the patterned surface comprising at least one patterned groove. The bottom surface will frequently be closed for contacting with a heating source such as thermoelectric cooler (TEC) or another Peltier device.

As used herein, the microfluidic assembly comprising the silicon chip, and an instrument compatible with accepting said microfluidic assembly in order to orchestrate sample processing and/or reading the output generated following the reactions performed using the silicon chip, can be seen as forming an at least semi-automated system or fully-automated system, or an at least semi-automated or fully-automated platform, wherein the term “semi-automated” indicates that at least a part of the protocol as performed on the silicon chip of the microfluidic assembly was started or performed in a non-automated way by a user, e.g. at the bench-side, possibly manually, which may include addition of appropriate reagents or manipulation of the collecting device for releasing such reagents from included therein compartments, such as blisters with appropriate reagents. Usually said non-automated part of the protocol should be understood as relating to biological sample preparation, such as liquefaction and/or nucleic acid extraction, thus generating a pre-treated liquid sample or a liquefied biological sample that a user can guide into the microfluidic chip with the aid of the provided herein microfluidic assembly.

As used herein, the “volume” is the amount of three-dimensional space occupied by a matter (liquid, solid or gas). As specifically used herein, the term “volume of the protruding part” is to be construed as the volume of the external dimensions of the protruding part that enters into the sample well such that it creates a push that will assist a liquid loaded into the sample well to move forward in the feeder channel that extends from the sample well. As used herein, the term driving pressure is used to refer to the force that acts over appropriate surface while the lid of the assembly is closed and the protruding part is inserted into the sample well, which pushes on a liquid that was introduced into the sample well such that this liquid is moved forward.

As used herein, the term “sample”, is to be construed broadly as any liquid potentially comprising an analyte of interest, which liquid can be provided into the microfluidic assembly as disclosed herein for being guided into and processed within the patterned compartment (comprising at least one continuous groove) of a silicon chip for performing a test. As used herein, the analyte will usually be a target nucleic acid to be detected within the silicon chip. The sample can be a liquid biological sample obtained from an individual, for example blood, but it can also be a biological sample that was pre-processed on a bench in accordance with any sample processing protocol, for example involving liquefaction of the sample or nucleic acid isolation, for generating a liquid that can be loaded into the chip.

As used herein, the analyte will usually be a target nucleic acid to be detected with the help of the reactions performed within the microfluidic chip. The analyte will preferably be a detectable nucleic acid, usually being a nucleic acid of a pathogen, e.g. viral DNA or RNA, but may also contain nucleic acid from the person from whom the sample was obtained such as genomic DNA, mitochondrial DNA, mRNA, rRNA, tRNA, microRNA etc.

Also, as used herein the term “nucleic acid isolation” is to be interpreted as any form of releasing nucleic acids from a biological material like its cellular context, to make it available for amplification.

It is also to be understood that the terminology used herein is for purpose of describing particular embodiments only and is not intended to be limiting. Further, although referred to as “preferred embodiments”, the various embodiments are to be construed as exemplary in which the invention may be practiced rather than as a limitation on the scope of the invention.

In addition, the terms first, second, third and the like are used in the specification and in the claims to distinguish between like elements and not necessarily to describe a sequential or chronological order. The terms are interchangeable under appropriate circumstances and the embodiments of the invention may be used in sequences other than those described or illustrated herein.

Furthermore, the terms top, bottom, over, below and the like in the specification and claims are used for illustrative purposes and not necessarily to describe relative positions. The terms so used are interchangeable under appropriate circumstances, and the embodiments of the invention described herein may be used in orientations other than those described or illustrated herein.

Furthermore, the words “comprising”, “including”, “containing” and similar wordings, in particular the term “comprising” as used in the claims, do not exclude other elements or steps and should not be construed as being limited to the means or steps set forth below. Further, the term “comprising” should be interpreted as merely specifying the presence of the named features, elements, steps, or components referred to, but does not exclude the presence or addition of one or more other features, elements, steps or components, or groups thereof. The scope of the expression “a device comprising means A and B” should therefore not be limited to devices consisting only of the components A and B. The meaning is that with respect to the present invention only the components A and B of the device are listed, and the claim is further to be interpreted as including equivalents of these components.

In addition, the verb “to consist essentially of” is to be construed as meaning that a list of elements or a composition “consisting essentially of” may comprise additional component(s) than the ones specifically identified, said additional component(s) not altering the unique characteristic of the invention. In addition, a method described “to consist essentially of” is to be construed as a method that may comprise additional step(s) than the ones specifically identified, said additional step(s) not altering the unique characteristic of the invention.

Throughout this disclosure, the term “comprising” may be replaced with the term “consisting essentially of”.

Further, as used in the specification and the appended claims, the articles “a”, “an”, “the”, and “said” include both singular and plural referents and are intended to mean that there are one or more of the elements unless the context clearly dictates otherwise. Thus, for example, reference to “a unit” or “the unit” may include several devices, and the like, or, for example, when referring to “an analyte” it is to be understood that one or more analytes can be present. As such, the terms “a” (or “an”), “one or more”, and “at least one” can be used interchangeably herein.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “multiple” in “multiple . . . ” or “multiple . . . ” is to be understood as referring to more than one, e.g. a plurality of . . . . In the context of a . . . , the term “multiple” will usually refer to more than 1, such as, 2, 3, 4, 5, 6, 7, 8, 9, 10 or in the range of multiples of 10.

As used herein, the term “and/or” indicates that one or more of the stated cases may occur, alone or in combination with at least one of the stated cases, up to with all of the stated cases.

### BRIEF DESCRIPTION OF FIGURES

For a fuller understanding, reference is made to the following detailed description taken in conjunction with reference to the accompanying figures in which:

FIG. 1 schematically shows a possible embodiment of the disclosed herein microfluidic assembly, presented in a form of a testcard comprising a silicon chip (1), which is shown as housed within a base structure (20). In this embodiment, the base structure comprises a baseplate (2), manufactured from a rigid and dark material that supports the chip and absorbs stray light, and a cover (3) comprising a sample well (31) for receiving a liquid sample, the closing lid (24, 34) with the protruding part (25, 35) for closing the sample well and adapted to generate a driving pressure for pushing the sample liquid through a feeder channel (32—not shown, visible in FIG. 3) and for providing assistance to said liquid to pass from said feeder channel into the silicon chip (1).

FIG. 2 schematically shows an embodiment of a microfluidic silicon chip (1) patterned with a meandering groove (11) for performing the assay, which chip (1) is covered by a glass plate (10), thus defining volume V1 within the groove for performing the assay on the chip. The inlet port (12) for accessing said volume V1 and the outlet port (13) adapted for venting the groove (11) are indicated accordingly;

FIG. 3 schematically shows an exploded view of the embodiment of FIG. 1 with channels including the feeder channel (32) and the vent channel (37b) visible at the bottom (“inner”) side of the cover (3);

FIG. 4 schematically shows an exploded view of the embodiment of FIG. 1 presented at a different angle than in FIG. 3;

FIG. 5 schematically shows an exploded view of the embodiment of FIG. 1 presented at a different angle than in FIG. 3 or FIG. 4;

FIG. 6 schematically shows an exploded view of an embodiment similar to the one of FIG. 1 and at an angle similar to the one of FIG. 5, wherein the embodiment further comprises a hydrophobic wet-out membrane (5) provided inside of a membrane chamber (36) sealed with an additional cover (51);

FIG. 7 schematically shows a cover of the embodiment of FIG. 5, wherein the hydrophobic wet-out membrane (5) and a membrane chamber (36) are not sealed;

FIG. 8 schematically shows an exploded view of an embodiment similar to the one of FIG. 6 but with different shape of the membrane chamber (36) and of the closing lid (34) that is still a part of the cover (3) as in the embodiments of FIG. 1, 3-7, but comprises a hollow protruding part (35);

FIG. 9 contains a photograph of an assembled prototype of the embodiment shown in FIG. 8 in the exploded;

FIG. 10 schematically shows the inner elements and connections between them of the prototype photographed in FIG. 9 and schematically shown in exploded view in FIG. 8 (upper pane). Zone placed in a dashed frame indicates the position of the photographed chip (1) zones as zoomed onto in the lower pane, wherein panel A shows empty inlet (12) and outlet (13) of the chip; while panel B shows the chip inlet (12) and chip outlet (13) filled with a dark liquid after creation of an additional pressure through closing of the lid (34);

FIG. 11 schematically shows another embodiment of an assembled microfluidic assembly as disclosed herein, also in a form of a testcard, wherein the closing lid (24) with a whole-body protruding element (25) is manufactured as part of the baseplate (2) and not the cover as in the previously presented embodiments of FIGS. 1, 3-10;

FIG. 12 schematically shows the embodiment of FIG. 11 but shown at a different angle; and lastly

FIG. 13 schematically shows another embodiment of an assembled microfluidic assembly as disclosed herein and in a form of a testcard wherein the housing structure (20) is manufactured as one piece with the closing lid (24) with a hollow-body protruding part (25). In this embodiment the chip (1) is slid into the pocket (21), thus eliminating the need of using a cover. The channels are present on the bottom side of the housing structure (20) and created as recesses covered with a channel-shielding element (4) in a form of a foil, with also participates in fixing the position of the chip (1).

### DETAILED DESCRIPTION

The invention generally concerns an improved microfluidic assembly design for guiding a liquid provided by a user, e.g. a liquified (pre-processed) biological sample, into a microfluidic compartment patterned within a silicon chip for performing a diagnostic test.

The present invention will be described with respect to certain embodiments and with reference to certain figures, but is not limited thereto and is defined only by the claims. The figures as referred to in the present description are non-limiting, schematic, and serve the purpose of aiding the understanding of the general concepts underlying the presented herein invention.

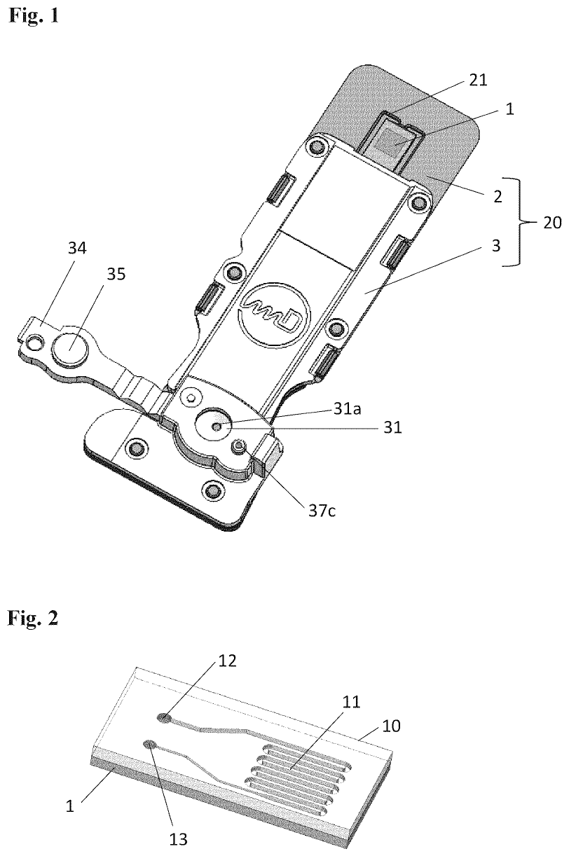

For example, the microfluidic assembly as disclosed herein, can be made in a form of a test card such as the one shown in the exemplary embodiment in FIG. 1. In this exemplary embodiment, the test card is shown housing the silicon chip (1), an exemplary embodiment of which is shown in FIG. 2. The chip (1) comprises a compartment for performing a diagnostic test, which is patterned into the chip's (1) body by any method known in the art, for example etching or other form of patterning. For illustrative purposes the chip (1) is shown to comprise a continuous groove (11) for performing a diagnostic test, i.e. comprising at least one compartment or zone within the patterned groove, which is adapted to perform the diagnostic test or a step being a part of a multi-step diagnostic tests wherein different steps are designed to take place in different zones positioned along the length of the continuous groove. The exemplary embodiment of the chip of FIG. 2 is further shown to comprise a glass plate (10), an inlet port (12) for accessing the groove (11) and the outlet port (13) adapted for venting the groove (11), but as it will be immediately evident to the skilled person, other chip (1) designs and architectures are equally well possible and applicable for employing with the microfluidic assemblies as disclosed herein.

As it will be understood by the skilled person, for illustrative purposes, the sizes of certain elements in the figures may be exaggerated and not drawn to scale. Furthermore, due to inherent limitations of two-dimensional representation of actual three-dimensional objects, the skilled person will understand that it may be that certain dimensions and/or relative dimensions as illustrated in certain figures may differ in real-life executions of three dimensional microfluidic assemblies made in accordance with the invention. Similarly, the skilled person will understand that inner elements as e.g. schematically shown in exploded views or indicated as visible through other elements, may not be visible in the physical executions of the microfluidic assemblies as described herein. For aiding the technical understanding further, photographs of exemplary and non-limiting prototype embodiments of the invention were also included for purely illustrative purposes.

In a first general aspect, the invention concerns a microfluidic assembly for guiding a liquid, for example a liquid biological sample or a pre-processed (for example lysed using a lysis buffer and/or enzymatic treatment) biological sample in a liquid form, to such silicon chip (1) comprising a continuous groove (11) for performing a diagnostic test, the assembly comprising:
a housing structure (20) for housing the silicon chip (1);
a sample well (31) for receiving the liquid;
a first outlet port (33) at the housing structure adapted to guide the liquid to the continuous groove (11) of the silicon chip (1) when housed;
a feeder channel (32) extending from the sample well (31) to the first outlet port (33); and
a closing lid (24, 34) comprising a protruding part (25, 35) adapted to close the sample well (31);
   the assembly characterized in that the volume of the protruding part (25, 35) is adapted to the volume of the feeder channel (32) such that when closing the sample well (31) after providing the liquid thereto (e.g. after filling it with the liquid), a driving pressure is created for assisting the liquid to pass from the first outlet port (33) (via the inlet (12) of the continuous grove (11) to the continuous groove (11) of the silicon chip (1) when housed.

In accordance with the first aspect, a microfluidic assembly for performing a diagnostic test is provided, the assembly comprising:
a silicon chip (1) comprising a continuous groove (11);
a housing structure (20) for housing the silicon chip (1);
a sample well (31) for receiving the liquid;
a first outlet port (33) at the housing structure adapted to guide the liquid to the continuous groove (11) of the silicon chip (1);
a feeder channel (32) extending from the sample well (31) to the first outlet port (33); and
a closing lid (24, 34) comprising a protruding part (25, 35) adapted to close the sample well (31);
   characterized in that the volume of the protruding part (25, 35) is adapted to the volume of the feeder channel (32) such that when closing the sample well (31) after providing the liquid thereto, a driving pressure is created that is sufficient to provide an additional push for assisting the liquid present in the feeder channel (32) to pass from the first outlet port (33) to the continuous groove (11) of the silicon chip (1), thereby initialling a jump of a least a portion of the liquid into the continuous groove (11), which allows to fill said groove with the liquid.

The purpose of the housing structure (20) is to accommodate or comprise the silicon chip (1). To this end, the shape of the housing structure (20) will be selected such to be suitable for accommodating the silicon chip (1). In some embodiments, the shape of the housing structure (20) is further adapted accommodate or comprise the silicon chip (1). In a preferred embodiment, a microfluidic assembly is provided comprising the silicon chip (1) fixedly housed within and/or connected to the housing structure (20).

To accommodate the silicon chip (1), the housing structure may, for example, comprise an indented pocket (21) adapted to hold, carry, contain, or accommodate the silicon chip (1). The indented pocket may be or comprise an opening like a through-hole, a chamber, a socket, or a compartment within the housing structure (20) of the assembly suitable for holding the silicon chip (1). In a preferred embodiment, the housing structure (20) of the microfluidic assembly comprises an indented pocket (21) for accommodating and/or containing the silicon chip (1). In addition to or alternatively to the indented pocket (21) and detection window can be provided (22), which can be transparent or hollow (a through-hole) in order to allow preforming a reading on a chip while still enclosed in the assembly and with minimal to no interference with the reading system. Such window (22) may but does not have to be provided as part of the indented pocket (21).

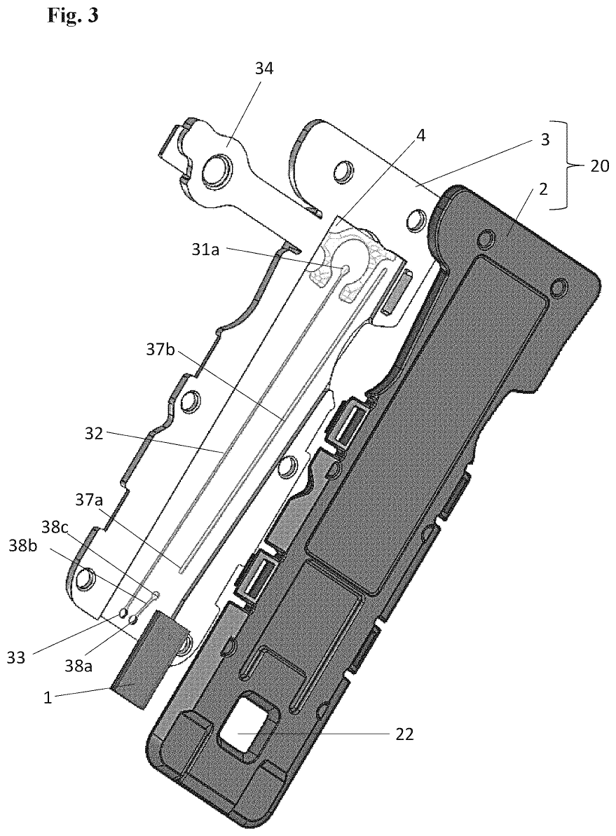

The microfluidic assembly of the disclosure aims to guide a liquid (like a liquid biological sample) to a silicon chip (1) for performing a diagnostic test after a user loads the liquid into the sample well (31) that can have any shape, for example it can be a concave or cone sheet, i.e. a dyke shaped in cross-section like a part-sphere or a cone, respectively, dipping inwards towards the innermost point, advantageously centrally positioned. In the exemplary embodiment of FIG. 1, the point is marked by an opening (31a) at the bottom of the sample well (31), which leads into a feeder channel (32). The feeder channel (32) and the first outlet port (33) of exemplary embodiment shown in FIG. 1 are visible in the exploded bottom view of said embodiment shown in FIG. 3.

A sample can be any liquid potentially comprising an analyte of interest that can be analysed by the silicon chip. The analyte can be a target nucleic acid to be detected with the help of the silicon chip (1). The sample can be a liquid biological sample obtained from an individual, but it can also be a biological sample that was pre-processed on a bench in accordance with any sample processing protocol, for example involving liquefying of the sample or preforming of a nucleic acid isolation (purification), in order to be able to provide such pre-processed sample into the chip. Such pre-processed sample will potentially contain a detectable analyte, usually a nucleic acid. In most cases the nucleic acid is of a pathogen, e.g., viral DNA or RNA, but it may also contain nucleic acid from the person from whom the sample was obtained such as genomic DNA, mitochondrial DNA, mRNA, rRNA, tRNA, microRNA etc. Alternatively, the nucleic acid may be of an exogenous origin contaminating a casework sample, such as exogeneous bacterial, viral, fungal, etc. contaminating species.

The sample well (31) serves the purpose of receiving the sample liquid for diagnostic testing and is made from appropriate material and adapted to accept the liquid and facilitate its transfer into the feeder channel (32) of the assembly. The sample well (31) thus facilitates the loading of a sample liquid by the user into the microfluidic assembly. It is to be understood that a sample can be loaded into the sample well (31) by different means known in the art, such as with a use of a pipette, a syringe, a dosing applicator, or even a measuring cylinder, etc. The term loading volume of the sample well (31) is to be construed as the maximal sample volume which can be loaded into the sample well (31) without spilling. Advantageously, the sample well will be adapted to accept relatively small volumes of sample liquid, defined as the volume that lies between 1 μl and 50 μl. Accordingly, it is to be understood that the loading volume of the sample well (31) may be 1 μl, 2 μl, 3 μl, 4 μl, 5 μl, 6 μl, 7 μl, 8 μl, 9 μl, 10 μl, 11 μl, 12 μl, 13 μl, 14 μl, 15 μl, 16 μl, 17 μl, 18 μl, 19 μl, 20 μl, 21 μl, 22 μl, 23 μl, 24 μl, 25 μl, 30 μl, 35 μl, 40 μl, 45 μl or 50μl. Preferably, the loading volume of the sample well (31) lies between 4μl and 50μl. Most preferably, the loading volume of the sample well (31) is 5 μl to 10 μl.

The microfluidic assembly further comprises a closing lid (24, 34) for closing the sample well (31), the closing lid (24, 34) comprising a protruding part (25, 35). The closing lid (24, 34) may be a cap, a stopper, a plug, or another type of closure. Closing of the sample well (31) is achieved by inserting at least a part of the closing lid (24, 34) into or onto the sample well (31) so that the protruding part (25, 35) becomes positioned inside of the sample well (31). An example of a suitable closing lid (24, 34) is a double hinged sample cap. The shape of the closing lid (24, 34) is adapted to be compatible with the shape of the sample well (31) so that a secure closing of the sample well (31) can be achieved.

Overstretching of the closing lid (24, 34) upon closing of the sample well (31) with the closing lid (24, 34) may cause difficulty of closing and may pressure the system. This is especially the case when a hinged closing lid (24, 34) is used since the hinge of the closing lid (24, 34) is very flexible and provides multiple degrees of freedom for moving the protruding part (25, 35) of the closing lid (24, 34) into the sample well (31). Accordingly, in certain embodiments, the microfluidic assembly is provided constructed such to help correct closing of the sample well (31). Advantageously, the outside wall of the sample well (31) may comprise or be connected to additional structures for guiding the closing of the closing lid (24, 34), such as a rib or additional guides, to lead closure and preventing overstretching of the closing lid (24, 34) upon closing the sample well (31).

The volume of the protruding part (25, 35) of the closing lid (24, 34) is adapted to the volume of the feeder channel (32) of the assembly so that an additional driving pressure is created for assisting the liquid to pass towards the continuous groove (11) of the silicon chip (1). Similar as with the closing lid (24, 34), the shape of the protruding part (25, 35) is adapted to be compatible with the shape of the sample well (24, 34) so that, upon closing of the sample well (31) with the closing lid (24, 34), the protruding part (24, 35) tightly fits inside of the sample well (31). The volume or shape of the protruding part (24, 35) is adapted such that, when the sample well (31) is closed with the closing lid (24, 34) comprising the protruding part (25, 35), a suitable amount of sample liquid still fits within the sample well (31). It is therefore to be understood that the length of the protruding part (25, 35) (measured along the depth the protruding part (25, 35) enters into the sample well (31) from its lowest point) may vary up to the point it almost entirely or fully fills the sample well (31) when closed.

In an advantageous embodiment, a sealing edge (not shown) is provided on the outer part of the protruding part (24, 35). Such sealing edge may further help with the generation of an additional pressure and of a tight seal between the closing lid (24, 34) in the sample well (31), which is useful to prevent lifting of the closing lid (24, 34) during usage of microfluidic assembly, especially during processing in the reader, in particular involving temperature changes such as during thermocycling.

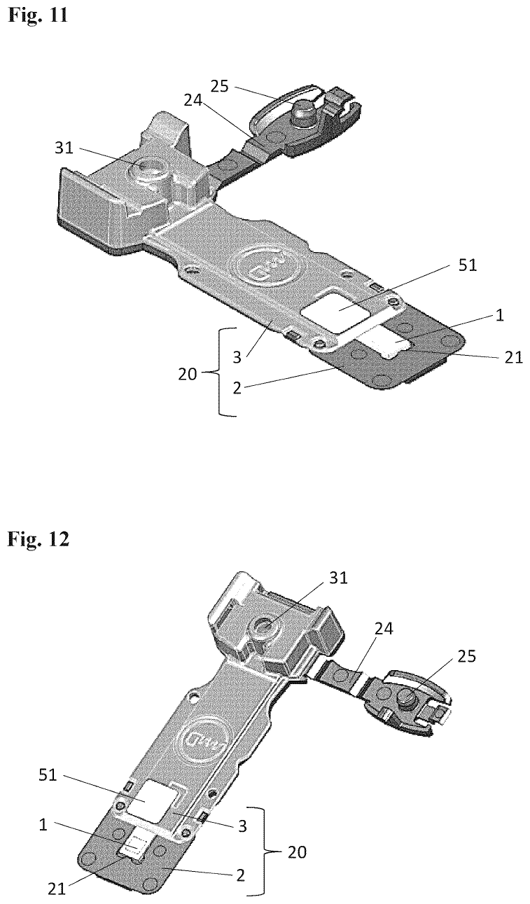

The closing lid (24, 34) and the sample well (31) may be constructed from different materials. FIG. 11 schematically shows an embodiment of an assembled microfluidic assembly in a form of a testcard, wherein the closing lid (24) with a whole-body protruding element (25) is manufactured as part of the baseplate (2) and the sample well (31) is manufactured as part of the cover (3), wherein the baseplate (2) and the cover (3) are of different materials. Embodiments wherein the cover (3) material has a composition different from the composition of the baseplate (2) material is advantageous for generating a tight seal between the closing lid (24, 34) and the sample well (31). A technical effect of such configuration is that the strength of the seal between the closing lid (24, 34) and the sample well (31) is improved.

A technical effect of the shape the protruding part (25, 35) of the closing lid (24, 34) is that closing the sample well (31) with said closing lid (24, 34) creates an additional driving pressure for the sample liquid to move towards the feeder channel (32). An advantage provided by such designed closing lid (24, 34) is that the transfer of the sample liquid from the feeder channel (32) towards the continuous groove (11) of the silicon chip (1) is promoted. The closing lid (24, 34) therefore ensures that the sample liquid is efficiently transferred towards the chip (1) for further analysis.

The closing lid (24, 34) of the assembly comprising the protruding part (25, 35) may create an additional driving pressure on the sample liquid of less than 20 N. The driving pressure created by the closing may be at least 0.5 N. In a preferred embodiment, the force of the driving pressure created on the sample by the closing lid (24, 34) comprising the protruding part (25, 35) lies between 0 N-20 N, 5 N-20 N, 10 N-20 N, or 15 N-20 N.

To further secure closing of the closing lid (24, 34), the microfluidic assembly may comprise one or more additional closing mechanisms, such as snap closures or hooks. In an embodiment, the microfluidic assembly further comprises a snap closure adapted to securely close the closing lid.

The sample well (31) may also be adapted in combination with the closing lid (24, 34) to improve the strength of the driving pressures required for guiding the sample through the microfluidic assembly. To this end, the shape of the sample well (31) may be adapted to its purpose and may have the conical or round shape, as described above, although it should be clear that other shapes are possible as well. In particular, the bottom of the sample well (31) may be round-shaped, conically shaped, flat bottomed with straight edges, or flat bottomed with curved edges, amongst other shapes. The shape of the sample well (31) determines the volume of the sample well (31). Accordingly, the volume of the sample well (31) can also be adapted to guide the desired volume of sample liquid through the microfluidic path of the assembly (e.g. the feeder channel (32) and the groove (11) of the chip (1) when housed, but possible also other fluidically connected compartments if present, depending on the embodiment design). As further discussed, the volume of the sample well (31) is preferably further adapted to correspond with the volume of the continuous groove (11) of the silicon chip (1), at least to the extent to drive to and fill said groove (11) with sufficient amount of liquid for performing the diagnostic test.

A technical effect of the shape of the sample well (31) of the microfluidic assembly is that it facilitates the loading of the sample liquid by the user into the assembly. An advantage thereof is that the user is able to accurately load small volumes (i.e., micro-and nanolitre volumes) of sample liquid into the microfluidic assembly. Consequently, another advantage of the sample well (31) is that it prevents spillage of valuable samples and prevents overloading of the microfluidic path made by channels of the assembly.

Once the sample liquid has been loaded into the sample well (31) and the closing lid (24, 34) of the sample well has been closed and the protruding element (25, 35) has entered into the sample well (31), the sample liquid will move towards the feeder channel (32) of the assembly. The feeder channel (32), or channel (32) in short, will usually be construed as an elongated space provided within the housing structure (20) of the assembly. The purpose of the feeder channel (32) is to guide or transfer the sample liquid from the sample well (31) towards the continuous groove (11) of the silicon chip (1). Accordingly, the position of the feeder channel (32) within the assembly is adapted to this purpose. In other words, the feeder channel (32) is preferably adapted to extend from the sample well (31) to the continuous groove (11) of the silicon chip (1). The feeder channel (31) may have any shape and position depending on the liquid volumes intended to be handled vis-à-vis the design of the reader that will read the diagnostic test result performed inside of the chip (1), in particular to provide a safe distance between the sample well (31) from the reading zone within the reader, such as not to contaminate the reading zone with any potential spills or liquid droplets accidentally created by the user when loading the liquid in the sample well (31). Accordingly, the feeder channel (32) may extend from the sample well (31) to the continuous groove (11) of the silicon chip (1) when housed in a form of a straight channel, a curved channel, or a wavy or meandering channel. In a preferred embodiment, the feeder channel (32) of the microfluidic assembly is present as a straight channel, advantageously extending lengthwise along the longer edges defining the shape of the assembly, as schematically shown in FIG. 3.

The feeder channel (32) connects with the sample well (31), which connection may be manufactured without any additional fitting elements, for example in a form resembling a continuous funnel or can comprise one or more additional elements such as fitting elements, or valves or septa etc. In the exemplary embodiments of FIGS. 1 and 3, the connection between the sample well (31) to the feeder channel (32) for filling the latter with a sample liquid is symbolically indicated by marking the presence of the opening (31a). On the opposite end of the feeder channel (32) with respect of the opening (31a), the feeder channel (32) ends with a first outlet port (33) for guiding the sample liquid from the feeder channel (32) to the continuous groove (11) of the silicon chip (1). The connection point at the opening (31a) and the first outlet port (33) form the entry points for the sample into the feeder channel (32) from the sample well (31) and from feeder channel (32) the continuous groove (11) of the silicon chip (1), respectively. Thus, the skilled person would understand that the feeder channel (32) can be described as extending from the sample well (31) to the first outlet port (33) of the feeder channel, wherein the outlet port (33) opens into and possibly is fixedly connected (e.g. using glue or other fixing and possibly adhesive material) to the inlet (12) of the continuous groove (11) of the silicon chip (11) when housed. The first outlet port (33) may be an opening, a cavity, an indent, a gap, a puncture, or a perforation in the feeder channel (32) or have any other form as would be described by the skilled person.

The dimensions of the feeder channel (32), along with the dimensions of other channels possibly present in the assembly as mentioned further herein according to possible further embodiments, are adapted to fit within the housing structure (20) of the microfluidic assembly, and to handle the low volumes of sample liquid. Accordingly, the depth of the channels of the microfluidic assembly may range from 0.1 mm to 0.5 mm. The channel depth can therefore lie between 0.1 mm-0.2 mm, 0.1-0.3 mm, 0.1 mm-0.4 mm, 0.2-0.3 mm, 0.2 mm-0.4 mm, 0.2 mm-0.5 mm, 0.3mm-0.4 mm, 0.3 mm-0.5 mm, or 0.4 mm-0.5 mm. Preferably, the channels are 0.2 mm deep.

The width of the channels of the microfluidic assembly may range from 0.1 mm to 0.5 mm. The channel width can therefore lie between 0.1 mm-0.2 mm, 0.1-0.3 mm, 0.1 mm-0.4 mm, 0.2-0.3 mm, 0.2 mm-0.4 mm, 0.2 mm-0.5 mm, 0.3 mm-0.4 mm, 0.3 mm-0.5 mm, or 0.4 mm-0.5 mm. Preferably, the channels are 0.34 mm wide.

The length of the channels of the microfluidic assembly may range from 0.5 mm to 50 mm. The channel length can therefore lie between 0.5 mm-1 mm, 0.5 mm-5 mm, 0.5-10 mm, 0.5 mm-15 mm, 0.5 mm-20 mm, 0.5 mm-25 mm, 0.5 mm-30 mm, 0.5 mm-35 mm, 0.5 mm-40 mm, 0.5 mm-45 mm, 0.5 mm-50 mm, 1 mm-5 mm, 1 mm-10 mm, 1 mm-15 mm, 1 mm-20 mm, 1 mm-25 mm, 1 mm-30 mm, 1 mm-35 mm, 1 mm-40 mm, 1 mm-45 mm, 1 mm-50 mm, 5-10 mm, 5 mm-15 mm, 5 mm-20 mm, 5 mm-25 mm, 5 mm-30 mm, 5 mm-35 mm, 5 mm-40 mm, 5 mm-45 mm, 5 mm-50 mm, 10 mm-15 mm, 10 mm-20 mm, 10 mm-25 mm, 10 mm-30 mm, 10 mm-35 mm, 10 mm-40 mm, 10 mm-45 mm, 10 mm-50 mm, 15 mm-20 mm, 15 mm-25 mm, 15 mm-30 mm, 15 mm-35 mm, 15 mm-40 mm, 15 mm-45 mm, 15 mm-50 mm, 20 mm-25 mm, 20 mm-30 mm, 20 mm-35 mm, 20 mm-40 mm, 20 mm-20 mm, 20 mm-50 mm, 25 mm-30 mm, 25 mm-35 mm, 25 mm-40 mm, 25 mm-20 mm, 25 mm-50 mm, 30 mm-35 mm, 30 mm-40 mm, 30 mm-45 mm, 30 mm-50 mm, 35 mm-40 mm, 35 mm-45 mm, 35 mm-50 mm, 40 mm-45 mm, 40 mm-50 mm, or 45 mm-50 mm. Preferably, the longest channel of the assembly is 45 mm long.

The microfluidic assembly may be construed from materials suitable to absorb stray light during the optical read-out of the silicon chip (1) by a reader adapted to accept and/or otherwise connect with at least a part of the microfluidic assembly and perform the reading of the diagnostic test performed using the chip (1). The material may advantageously further be selected such to avoid outgassing of the air within the assembly. To this end, the microfluidic assembly may be made from a material suitable to serve this purpose, such as polycarbonate, polypropylene, polymethyl methacrylate, polyethylene terephthalate, polyvinyl chloride, acrylonitrile-butadiene-styrene, polyethylene, polycarbonate, polypropylene, polymethyl methacrylate, polyethylene terephthalate, polyvinyl chloride, acrylonitrile-butadiene-styrene, or polyethylene.

In advantageous embodiments, the materials selected for producing the microfluidic assembly as disclosed herein, or at least the parts thereof that will enter in contact with the reader, will be heat-resistant, which is to be understood as capable of withstanding heat of at least 100° C., preferably of at least 110° C., more preferably of at least 120° C., or even of 130° C. or more for at least the time necessary for performing a thermocycling-based protocol. For microfluidic chips such time will be short, e.g. counted in minutes, such as 5, 10, 20, 30 minutes, it is however advantageous that such materials can withstand the above-specified heat values for at least 1 hour, at least two hours, at least 3 hours or longer.

As used herein, the term “reader” or, sometimes “chip reader” is to be construed as referring to a system or device for observing and possibly also recording signals from a chip. A chip reader typically comprises a chamber for engaging with and/or receiving at least a part of the fluidic assembly housing the chip (1), a recording device such as an image sensor (e.g., a camera), a means for transmitting the data collected from the assay to memory, and optionally, a light source such as a light-emitting diode (LED). Additionally, the chip reader may contain fluidic hardware such as pumps, channels, chambers for solutions, valves, mixers, and the like; and hardware and/or software for performing at least some analysis of the data. Miniaturized chip readers are known in the art.

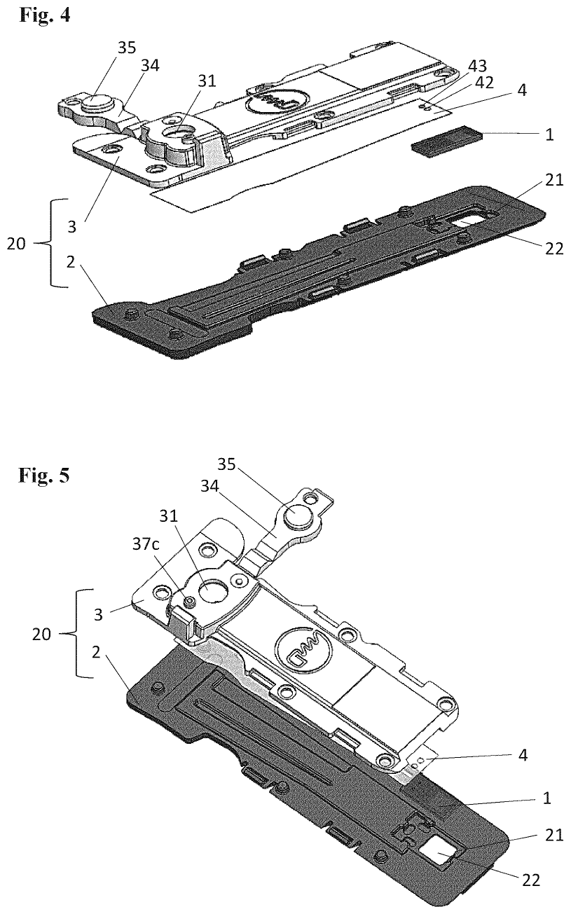

In advantageous embodiments, the sample well (31) is positioned on the opposite side of the microfluidic assembly's housing structure (20) relative to the side adapted to accommodate the silicon chip (1), being the side marked by the position of the indented pocket (21) adapted to hold or contain the chip (1) within the housing structure (20) as schematically shown in the exemplary embodiment of FIG. 1 and its exploded views in FIGS. 4, 5, and 6.

A technical effect of such positioning the sample well (31) away from chip housing zone (e.g. the zone marked by the position of the indented pocket (21)) of the housing structure (20), is that the occurrence of accidental splashes originating from the loading process of the liquid sample into the sample well (24, 34) or from closing the sample well (24, 34) with the closing lid (24, 34) is reduced. Typically, sample splashing or spattering may be caused by a human factor resulting in an inaccurate or perturbed loading of the sample liquid into the sample well (24, 34), which may result in the propelling of small liquid sample splashes or droplets out of the sample well in all directions. Not only are these sample droplets lost for downstream analysis within the silicon chip (1), they can also contaminate the reading zone during the optical read-out of the silicon chip (1) when the assembly is engaged with the chip reader. Accordingly, the technical advantage of sufficiently distancing the sample well (31) from the chip housing zone of the housing structure (20) is that the contamination of the reader can be prevented or at least substantially reduced or eliminated. Advantageously, the distance between the sample well (31) and the first outlet port (33) is at least 0.5 cm, preferably at least 1 cm, even more preferably at least 1.5 cm, most preferably at least 2 cm or, for the ease of handling, can be even longer if desired.

In order to position the sample well as far away as possible from the chip (1) housing zone (e.g. the indented pocket (21)) of the housing structure (20), the shape of the assembly may be adapted to allow distance between the sample well and the housing structure. Accordingly, in a preferred embodiment, the housing structure is predominantly elongated and/or beam-shaped. However, it should be understood that the assembly can have other shapes as well.

As already explained, when referring to possible preferred embodiments wherein the feeder channel (32) extends from the sample well (31) to first outlet port (33), which opens and/or connects to the inlet (12) leading to the continuous groove (11) of the silicon chip (1) housed in the housing structure (1), the skilled person would understand that the feeder channel (32) is positioned lengthwise along the assembly when the sample well (31) is positioned on the opposite side of the assembly than the zone of the housing structure (20) that houses the chip (1). Hence, in a preferred embodiment, the feeder channel (32) is positioned lengthwise along the assembly. Nonetheless, the feeder channel (32) may also be differently positioned within the assembly when the position of the sample well (31) and the first outlet (33) port is altered.

In line with the above, in a preferred embodiment, a microfluidic assembly is provided, wherein the assembly is predominantly beam-shaped and the feeder channel (32) is positioned lengthwise along the assembly.

The connection from the sample well (31) to the feeder channel (32) may be aligned with the opening (31a) from the sample well (31) so that the sample liquid is efficiently transported from the sample well (31) to the feeder channel (32). Similarly, the first outlet port (33) of the feeder channel may be aligned with the silicon chip to ensure efficient filling of the continuous groove (11) of the silicon chip with the sample liquid from the feeder channel (32). The width of the feeder channel (32) may further be adapted to prevent filling of the continuous groove (11) of the silicon chip before closing of the closing lid (24, 34). In some embodiments, the width of the feeder channel can be adapted to decrease towards the first outlet port (33) such that the overflowing towards the continuous groove (11) during filling is prevented. Hence, in an advantageous embodiment, a microfluidic assembly is provided, wherein the width of the feeder channel (32) is adapted to decrease towards the first outlet port (33) such that overflowing towards the continuous groove (11) during filling is prevented.

The microfluidic assembly as disclosed herein may be constructed as a multi-part assembly comprising multiple individually manufacturable components. In an embodiment, the microfluidic assembly may comprise the housing structure (20) in a form of a baseplate (2) for supporting the silicon chip when housed, and further a cover (3). The cover (3) of the microfluidic assembly aims to cover the baseplate (2). Furthermore, covering the baseplate (2) with the cover (3) may be used for making channels or sections thereof in the microfluidic assembly, including but not limited to a feeder channel (32), a vent channel (37b), and/or a connection channel (38b), as shown in FIG. 3 and explained in more details below. For example, such channels and/or sections thereof can be made by creation of channel beds as recesses in either one or both of the baseplate (2) and/or the cover (3) and then aligning and further joining the two together.

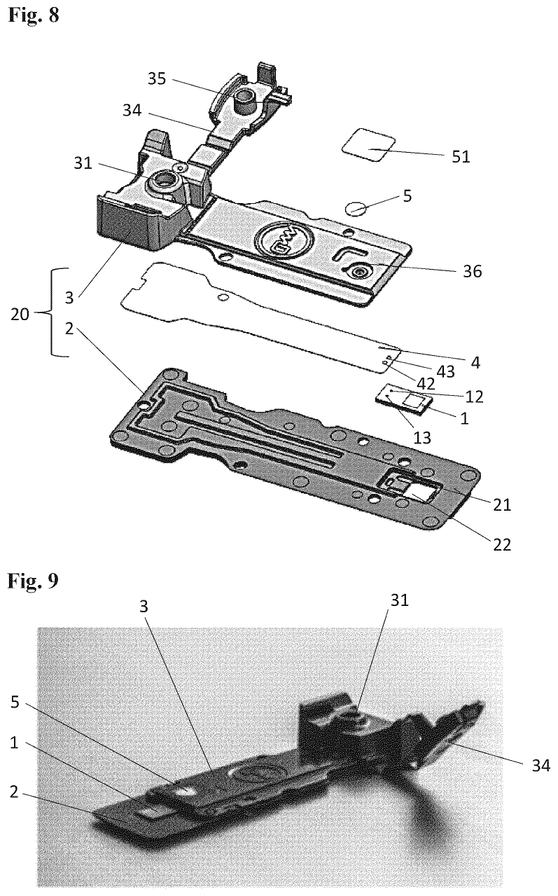

In advantageous embodiments of the disclosed herein microfluidic assembly, the cover (3) may be provided such that it at least partially covers and possibly further also stabilises and/or fixes the positioning of the silicon chip (1) within the assembly. Thus, in a preferred embodiment, a microfluidic assembly is provided, wherein the housing structure (20) comprises or consists of a baseplate (2) for supporting or substantially supporting the silicon chip (1) when housed, and a cover (3). In such embodiments, both the baseplate (2) and the cover (3) participate in housing and/or fixing the position of the silicon chip (1) when comprised as part of the assembly, and consequently can be regarded as two components of the housing structure (20) for housing the chip (1). Examples of such embodiments are shown in FIGS. 1, 10-12, their exploded views in FIGS. 3-6 and 8, a in a photograph of an exemplary embodiment prototype shown in FIG. 9.

Embodiments wherein the housing structure (20) comprises or is substantially made of a baseplate (2) and a cover (3) are advantageous from the manufacturing and assembling perspective. For example, such design provides flexibility with regard to the choice of materials, configuration and positioning of the channels, as well as provides the option of easily creating the channel beds in either or both of the baseplate (2) and/or the cover (3) and then creating the channels by covering such created channel beds with a channel-shielding element (4) for example a film or a foil, possibly an adhesive foil, which results in robustly closed channels that are not prone to leakages.

Further, such design facilitates the assembling process whereby a microfluidic silicon chip (1) of choice or carrying the diagnostic test of choice can easily be placed between the baseplate (2) and the cover (3) and then fixed between them in a simple manner and ensuring establishment of the intended connections in a correct manner along the microfluidic path extending from the sample well (31), through the housing structure (20) to the groove (11) of the chip (1) when housed.

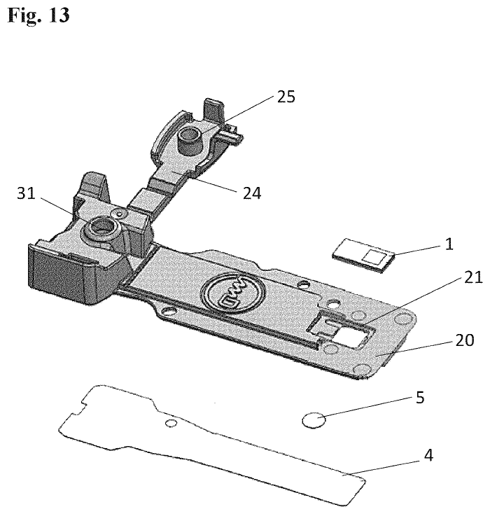

Alternatively, microfluidic assemblies as disclosed herein but comprising the housing structure (20) as one piece monobloc with channels moulded inside the housing structure (20) are also possible. Advantageously, however, an assembly comprising a housing structure (20) may also use a channel-shielding element (4) to cover channels created as one or more recesses formed on a surface with the housing structure (20). Such embodiment comprising a single-piece housing is shown in exploded view in FIG. 13. In this embodiment, the channels are manufactured on the bottom side of the housing structure (20) as recesses which are covered with a channel-shielding element (4) like a foil. Depending on the design, the channels can be on either side of the housing structure (20). In this embodiment the chip (1) is intended to be mounted into the housing structure by a sliding movement into the pocket (21), where it is additionally stabilised by an adhesive foil (4) serving primarily as the channel-shielding element (4). Other designs and chip (1) positioning means are possible.

Alternatively, a microfluidic assembly can be provided comprising a channel shielding-element (4) comprising at least a section of a channel, for example a section of or an entire feeder channel (32), made inside the channel-shielding element (4). This can be achieved by a provision of a multi-layer channel-shielding element (4) comprising at least three layers that include two external layers and at least one internal layer, wherein the at least one internal layer comprises a through-hole defining the channel body (of the section thereof). By “sandwiching” or sealing the at least one internal layer comprising the through-hole between the two external layers, the section of the channel can be formed. For example, the at least one inner layer can be made of plate that is adhesive on both sides that is then covered by two foils as the external layers. Such external layers can then contain smaller through holes or punctures adapted to connect with e.g. sample well (31) and/or the inlet (12) of the groove (11) of the chip (1). Such made channel-shielding element (4) can be provided as part of a one piece housing structure (20) or as a part of a housing structure (20) comprising a baseplate (2) and a cover (3). In case such channel-shielding element (4) participates in stabilising the chip (1) within the housing structure (20) and/or the baseplate (2) thereof and/or between the baseplate (2) and the cover (3), the channel-shielding element (4) can be regarded as comprised by the housing structure (20).

In order to better support the silicon chip (1) when housed, in advantageous embodiments, the housing structure (20), or in particular, the baseplate (2) and/or the cover (3) may be provided with specific substructures, for example indentations and/or pockets like the indented pocket (21), for keeping the chip (1) in place and/or ensuring that the inlet (12) of the chip's (1) groove (11) aligns correctly with the first outlet port (33) at the housing structure.

As briefly mentioned above, the channels of the disclosed herein microfluidic assembly may be formed entirely within or partially by creating a channel bed in a form of a recess in any one or both of the baseplate (2) and/or the cover (3). In such embodiments, at least a part of the sidewall that defines the channel is made by such a recess, while the remaining part of the sidewall can be provided through shielding the recess by another element, thus closing the sidewall and defining a channel. For example, a channel or a section thereof or a chamber through which the channel or the section thereof passes may be formed by first creating a recess present in both the baseplate (2) and the cover (3), whereby through joining of the corresponding recesses, the channel or the section thereof or the chamber is closed and thus formed. Alternatively and advantageously, a channel or a section thereof or a chamber through which the channel or the section thereof passes may be formed by first creating a recess present in either one or both the baseplate (2) and the cover (3) and then by sealing such recesses by provision of a channel-shielding element (4) and thus closing the sidewall and creating the channels, sections thereof or chambers, respectively. The channel-shielding element (4) can be anything suitable to close the open part above a recess defining a channel, a section thereof, or a chamber; for example it can be a foil, or a plastic shield, or a piece of a metal plate, possibly and advantageously it can be an adhesive foil. The channel-shielding element may comprise one or more openings, holes, gaps, slots, punctures or fissures that align with any of the structures of the assembly when required by the design or simply advantageous from the perspective of an improved stability and/or ease of the assembling process. For example, a hole may be present to align with e.g. the first outlet port (33) of the feeder channel (32) or the inlet (12) leading to the continuous groove (11) of the silicon chip (1), or any other openings provided for venting functionality, if present, as described below.

Alternatively, one or more of the channels or sections thereof of the disclosed herein microfluidic assembly may be formed by creating a channel bed in a form of a recess in any one of the baseplate (2) and/or the cover (3) and/or the channel-shielding element (4). The channel in the channel-shielding element (4) will usually be attached to the housing structure (20), for example to the baseplate (2) and/or the cover (3). Possibly, in line with what was briefly explained above, the channel in the channel-shielding element (4) can be formed by sandwiching layers containing through-holes to form a channel-shielding element (4) that is laminated and/or made of multiple layers, wherein at least one layer or laminate layer forms a recess (channel bed) of the channel-shielding element (4). In an alternative embodiment, the channel-shielding element (4) can be provided as a plate or a foil comprising a through-hole defining the shape and/or the length of a future channel, wherein the channel becomes formed by sandwiching such channel-shielding element (4) between both the baseplate (2) and the cover (3), which both become attached on both sides of the channel-shielding element (4). In such an embodiment, a channel is formed by closing the through-hole made inside of and extending within the channel-shielding element (4) that is shielded from both of its major sides by the cover (3) and the baseplate (2) of the housing structure (20).

In a preferred embodiment, at least part of the feeder channel (32) (i.e. at least a part of the side wall defining the feeder channel (32)) is formed as a recess present in either one or both of the baseplate (2) and/or the cover (3). Further, in this and alternative embodiments, any channels, sections thereof or chambers can also be moulded or made by other methods within the body of the baseplate (2) and/or the cover (3). As it will be readily understandable by the skilled person, a fluidic path running through a microfluidic assembly as disclosed herein, may be made by combining any of the above described channel making methods. For example, a fluidically continuous path can be made extending from a sample well (31) made in a cover (3), such as the cover shown in FIG. 7, wherein a first section of a feeder channel (32) directly extending from the sample well (31) is made as a foil-sealed recess made within the cover (3) on the opposite cover side (“bottom” or “inner” side of the cover (3)) with respect to the side containing the opening of the sample well (31) (“upper” or “outer” side of the cover (3)). Then, in a possible embodiment, a further section of the feeder channel (32) may pass through a chamber made by joining recesses both in the inner (“bottom”) side of the cover (3) and in the inner (“upper”) side of the baseplate (2) facing the inner side of the cover (3), and then continue as a yet another section of the feeder channel (32) towards the first outer port (33) leading to the chip (1) and made as a foil-covered recess created in the inner side of baseplate (2).

In a preferred embodiment, a microfluidic assembly is provided, wherein at least part of the feeder channel (32) is formed as a recess present in either one or both of the baseplate (2) and/or the cover (3), preferably wherein at least part of the feeder channel (32) is formed as a recess present in the cover (3), most preferably wherein the feeder channel (32) is formed as a recess present in the cover (3).

The housing structure (20), or either one of the baseplate (2) or the cover (3) of the assembly or of the housing structure (20) may be adapted to absorb stray light during the optical read-out process performed on the silicon chip by a chip reader. To this end, the housing structure (20), the baseplate (2) and/or the cover (3), advantageously at least the baseplate (2) may be made from a material suitable to serve this purpose, such as polycarbonate, polypropylene, polymethyl methacrylate, polyethylene terephthalate, polyvinyl chloride, acrylonitrile-butadiene-styrene, or polyethylene, which is made such to have stray-light absorbing properties, for example has a dark colour like black or near black (dark grey etc.). In a preferred embodiment, at least the baseplate (2), possibly also the cover (3), is made from a light-absorbing (e.g. dark-coloured) polycarbonate material.

The housing structure (20), or either one of the baseplate (2) or the cover (3) of the assembly or of the housing structure (20) may also be adapted to avoid outgassing of the air within the assembly. To this end, the housing structure (20), the baseplate (2) and/or the cover (3), advantageously at least the cover (3) may be made from a material suitable to serve this purpose, such as polycarbonate, polypropylene, polymethyl methacrylate, polyethylene terephthalate, polyvinyl chloride, acrylonitrile-butadiene-styrene, or polyethylene. In a preferred embodiment, at least the cover (3), possibly also the baseplate (2) is made from a polypropylene material. In a more preferred embodiment, the cover when present is made from a polypropylene material, and the baseplate when present is made from a polycarbonate material.

As briefly explained above, in some embodiments, the microfluidic assembly may further comprise a channel-shielding element (4) for forming a wall of at least one channel. The channel-shielding element can be provided such to cover any zone of the housing structure (20), for example within the baseplate (2) and/or the cover (3) if present, to at least partly form any or all of the channels, sections thereof, or chambers of the microfluidic assembly. The channel-shielding element (4) may be a piece of a thin flexible sheet of foil, tape, or adhesive of any type. Such a foil, tape or adhesive may be made from plastic or metal or polymer, or another type of a suitable material as it will be evident those skilled in the art. In a preferred embodiment, the channel-shielding element (4) is a silicone-based pressure sensitive adhesive (PSA). Advantageously, the channel-shielding element (4) is a heat-resistant silicone-based PSA. As explained above, advantageously, the channel-shielding element will be able to withstand at least 100° C., preferably at least 110° C. to even 130° C., for at least a minute or more, to ½ hr, or 1 hr, even to up to 3 hr or more. The channel-shielding element can be laminated and/or made of multiple layers. To prevent leakages, the channel-shielding element (20) will usually be attached to the housing structure (20), for example to the baseplate (2) and/or the cover (3).

In line with the above, in an embodiment, a microfluidic assembly according is provided further comprising a channel-shielding element (4) attached to the housing structure (20), preferably positioned between the baseplate (2) and the cover (3), if present. In a specific possible embodiment of the previous one, a microfluidic assembly is provided, wherein at least part of the feeder channel (32) is formed between the recess and the channel-shielding element (4). For example, in advantageous embodiments, a microfluidic assembly is provided wherein at least a part of the feeder channel (32) is formed between the channel-shielding element (4) and a recess present in the housing structure (20), preferably being a recess present in either one or both of the baseplate (2) and/or the cover (3), advantageously being a recess present in the cover (3).

The skilled person would understand that, when the channel-shielding element (4) is provided, different channels of the microfluidic assembly, including but not limited to a feeder channel (32), a vent channel (37b), and/or a connection channel (38b) may also be formed as recesses covered (i.e. closed) with the channel-shielding element (4). For example, these channels may be formed by recesses present in the cover (3) and/or recesses present in the baseplate (2). Alternatively, the channel-shielding element (4) may also comprise a recess, for example formed as a through-hole in one of multiple layers making a multilayer channel-shielding element. Such recess in the channel-shielding element may then be attached over a straight surface of the housing structure (20), or of the baseplate (2) or the cover (3), thus also forming a channel, for example the feeder channel (32) or a different channel. As it will be apparent the skilled person, there are many ways of creating the feeder channel (32) or other different channels of the disclosed herein assembly, including but not limited to alignment of corresponding recesses present in both the baseplate (2) and the cover (3), or in the cover (3) and the channel-shielding element (4), or the channel-shielding element (4) and the baseplate (2), which may all be present in different embodiments of the disclosed herein assembly and to different extents. It is to be understood that when the feeder channel (32) is formed by a recess (also referred to sometimes herein as a channel bed, being a part of a channel that defines its future shape but whose sidewall is not complete) present in only one of the elements of the assembly, said recess must be closed by covering with a second element of the assembly to form a channel. As used herein, the term channel should be understood as referring to a structure within the microfluidic assembly that defines a fluidic path and having a hollow body suitable for sustaining a fluidic flow and defined by one or more side walls surrounding the hollow body. Possibly, a channel may have sections that are tube-like, likely, however, the channel's cross-section will be variable in size and shape over its length and comprise sections that are not perfectly circular, enlarged (that can be regarded as chambers), and/or comprise at least one straight side-wall, e.g. when a rigid channel-shielding element (4) is used to form a part of the channel by covering a recess within a surface of the housing structure (20). For instance, when a channel is formed by a recess in the cover (3), the channel may further be covered by the baseplate (2) or by the channel-shielding element (4)

When the microfluidic assembly is constructed as from multiple parts, the sample well (31) may e.g. be a part of the cover (3), or a part of the baseplate (2), or a part of the cover (3) and of the baseplate (2). In an embodiment, the sample well (31) is part of the baseplate (2) and/or the cover (3). In most embodiments, the sample well (31) comprises an opening (31a) that will usually be present at the bottom of the well (31) and serves transferring the sample liquid from the sample well (31) into the feeder channel (32). If manufactured from initially separate components, the opening (31a) of the sample well (31) is adapted to align with the entry into the feeder channer (32). In some embodiments, the transition from the sample well (31) to the feeder channel (32) will be continuous and funnel-like, with the opening (31a) resembling the inner opening at the narrower end of a cone of a funnel. The opening (31a) may be any type of an opening as classifiable by the skilled person, including a cavity, an indent, a gap, a puncture, or a perforation etc.

To avoid an undesired build-up of pressure caused by air trapped in certain embodiments of the disclosed herein assembly, provision of venting structures may be advantageous, such as channels and/or chambers allowing airflow and leading to the outside of the assembly, possibly by one or more vents. In order to provide an airflow throughout the microfluidic assembly, which advantageously allows aeration of the continuous groove (11) of the silicon chip (1) (for example being the chip (1) closed with a glass plate (10) as shown in FIG. 2), the microfluidic assembly of the disclosure may further comprise structures specifically adapted to vent the continuous (11) groove of the silicon chip (1) during filling. As shown in the chip embodiment in FIG. 2, one such structure can be a second outlet port (13) at an end of the continuous groove (11) of the chip (1), which second port (13) is useful to allow exiting of not only the air trapped in continuous groove (11) of the chip (1) but also excess sample should the latter were provided at a volume excessing the volume of the groove (11) within the chip. In line with the above, in an advantageous embodiment, an assembly is provided further comprising a second outlet port (13) at an end of the continuous groove (11) of the chip (1), which is adapted to vent said continuous groove (11) of the silicon chip (1) when housed, and preferably further allow exiting of excess sample from within the chip (1).

In some embodiments, the microfluidic assembly may further comprise an outlet vent (37c) at the housing structure (20), possibly at either or both of the baseplate (2) and/or the cover (3), the outlet vent (37c) preferably opening to a vent channel (37b) provided in fluid communication with the second outlet port (13) ending the groove (11) of the chip (1) and adapted for their venting during filling.

Hence, in another advantageous embodiment, a microfluidic assembly is provided, wherein the housing structure further comprises an outlet vent (37c) and a vent channel (37b). For example and depending on the embodiment, the vent channel (37b) either connects directly with the second outlet port (13) through the vent channel opening (37a) directly abutting the outlet port (13) and serving as an inlet of air therefrom into the vent channel (37b). Alternatively, the vent channel (37b) may be connected indirectly via the vent channel opening (37a) into an isolated specially provided and closed chamber space that connects to or holds the second outlet port (13), In case of the indirect connection, the vent channel (37b) remains in fluid communication with the second outlet port (13) through additional structures like the chamber space, or advantageously through a filter or a membrane allowing air passage but configured to block or stop any spills originating from the chip (1).

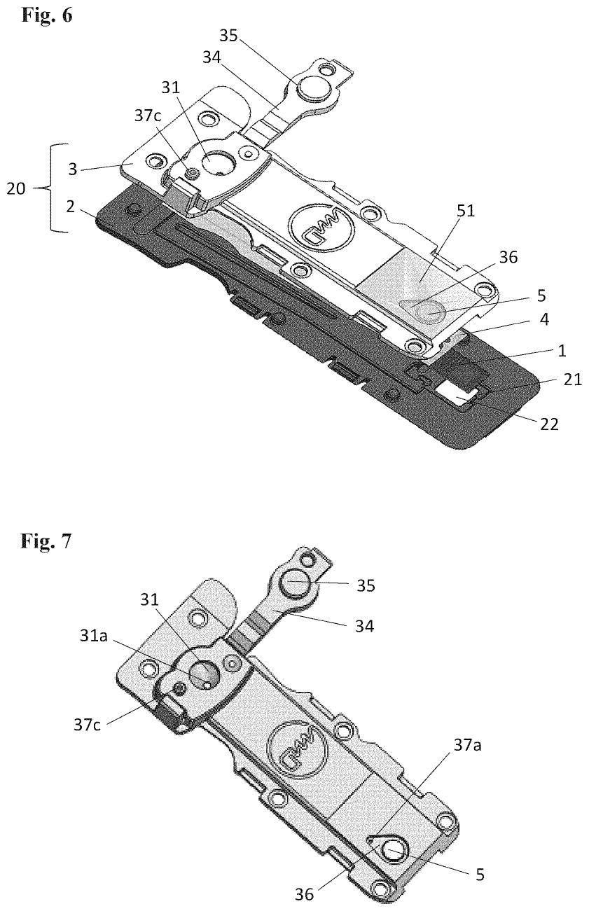

In a further advantageous embodiment, the vent channel opening (37a) opens to a chamber comprising a wet-out filter or a membrane, and consequently is termed a membrane chamber (36). Preferably, the wet-out structure provided in the membrane chamber (36) will be a hydrophobic membrane (5) adapted for blocking a passage of a liquid while allowing airflow. Embodiments of the assembly comprising a hydrophobic membrane (5) positioned inside of the membrane chamber (36), possibly covered by a membrane chamber cover (51) are shown in FIGS. 6-10.

In line with the above, in an embodiment, a microfluidic assembly is provided, wherein the housing structure (20) further comprises a membrane chamber (36) fluidically connected with or adapted to cover the second outlet port (13), the membrane chamber (36) comprising a hydrophobic membrane (5) adapted for blocking a passage of liquid while allowing airflow. The membrane chamber can also be localised in the baseplate (2) or in the cover (3), or between both, in case the housing structure (20) comprises the baseplate (2) and the cover (3).

In an advantageous embodiment, microfluidic assembly of the type as described above is provided, wherein the membrane chamber (36) further comprises a vent channel opening (37a) adapted for venting, preferably the vent channel opening being fluidically connected with a vent channel (37b) that ends with an outlet vent (37c).

Another possible venting structure may be a short connection channel (38b) that is made for ensuring fluid communication between the second outlet port (13) and an isolated specially provided and closed chamber space that connects to or holds at least the part of chip (1) with the second outlet port (13), the space preferably comprising a wet-out filter or a membrane for spillage preventions, and most preferably being the membrane chamber (36) described above.

Hence, in another preferred embodiment, a microfluidic assembly is provided, wherein the housing structure (20) (or any one of the baseplate (2) and/or the cover (3), if present) further comprises a connection channel (38b) adapted to connect the membrane chamber (36) to the continuous groove (11). For example, this short connection channel (38b) may be described as starting with a connection channel inlet (38a) that abuts the second outlet port (13) at the ending of the continuous groove (11) of the silicon chip (1), from which the connection channel (38b) extends to and ends with a connection channel outlet (38c) that terminates at the membrane chamber (36) holding a filter or a membrane that allows air passage (and thus also venting), stops excess liquid that may exit from the chip's (1) groove (11) via the second outlet port (13).

In further advantageous embodiments aimed to block passage of liquids from the second outlet port (13), and to possibly to retain the sample liquid in the continuous groove (11) of the silicon chip (1) while still allowing airflow, a membrane chamber comprising the hydrophobic membrane (5) is provided covering the second outlet port (13) directly. This hydrophobic membrane (5) may be provided as a covering layer able to repel liquid and resist liquid wetting. In a preferred embodiment, the hydrophobic membrane (5), is a hydrophobic microporous membrane. The skilled person would understand that a microporous membrane is a membrane containing pores with diameters less than 2 nm. In some embodiments, the hydrophobic membrane is located in a membrane chamber adapted to retain the sample liquid or a part thereof within the continuous groove (11) of the silicon chip (1). The membrane chamber (36) can be formed by a designated space in the assembly adapted to collect air. In some embodiments, the membrane chamber (36) is formed by a closed indented cavity, opening, or a notch in the assembly. In a preferred embodiment, the membrane chamber (36) is closed by a membrane chamber cover (51), advantageously being a single-sided adhesive tape. However, it is to be understood that other means can be used to close the membrane chamber (36). The air collected in the membrane chamber (36) can flow from the chip (1) through the hydrophobic membrane (5) to vent channel opening (37a), and subsequently to vent channel (37b), wherefrom it exists the assembly via the outlet vent (37c).

As mentioned above, the closing lid (24, 34) of the assembly comprising the protruding part (25, 35) creates an additional driving pressure for the sample liquid to move it from the feeder channel (32) towards and into the groove (11) of the chip (1). To this end, in advantageous embodiments, the membrane chamber (38) is further adapted to withstand the pressure provided by the closing lid (24, 34).

In certain embodiments, the membrane chamber (36) of the assembly is adapted to accumulate and further guide air. This air may be supplied to or drawn from the membrane chamber by means of a vent channel opening (37a) present at the membrane chamber (36). Alternatively, a notch and/or separate chamber may be present at the assembly instead of a vent channel opening (37a), to supply air to or draw air from the membrane chamber (36). When a vent channel opening (37a) is present in the membrane chamber, as explained above, the chamber (36) becomes further connected to a vent channel (37b) that ends in an outlet vent (37c) that is connected to the open air. This way, air is able to flow in and out from the outlet vent (37c), through the vent channel (37b) and into or out from the vent channel opening (37a) at the membrane chamber (36) so that air can travel into the membrane chamber (36).

The formation of venting channels may be analogous to the formation of the feeder channel (32) as described above. For example, in some embodiments at least part of the vent channel (37b) can be formed as a recess present in either one or both of the baseplate (2) and/or the cover (3), preferably wherein at least part of the vent channel (37b) is formed as a recess present in the cover (3), most preferably wherein the vent channel (37b) is formed as a recess present in the cover (3). In other embodiments, at least part of the vent channel (37b) is formed between the recess and the channel-shielding element (4) attached to the housing structure (20) from at least one of its sides or positioned between the baseplate (2) and the cover (3).

The volumes of the different channels present in the disclosed microfluidic assembly and/or the volume of the sample well (31) may be further adapted to prevent overfilling of the continuous groove (11) of the silicon chip (1). Accordingly, the volume of the sample well (31), the feeder channel (32), and if present the connection channel (38b), may be adapted to be equal to or larger than at least half of the volume of the continuous groove (11) of the silicon chip. Therefore, in an embodiment, a microfluidic assembly may be provided, wherein the sample well (31) defines a first capture volume V1, the feeder channel (32) defines a second capture volume V2, the connection channel (38b) if present defines a third capture volume V3, and the continuous groove (11) defines a reaction volume V4 for accepting the liquid, wherein the sample well (31), the feeder channel (32), and if present the connection channel (38b), are arranged to accept into one, two or all of the capture volumes V1, V2 and/or V3 the liquid that is exceeding the reaction volume V4, and wherein the sum of the capture volumes V1, V2, and, if present, V3, further referred to as V1+V2(+V3), is equal to or larger than at least half of the reaction volume V4 in accordance with the equation V1+V2(+V3)≥½V4.

The closing lid (24, 34) of the microfluidic assembly may be directly attached to the assembly, preferably directly attached to the housing structure (20) as shown in FIG. 13, but may also be provided as a separate, unconnected component. In a preferred embodiment, the closing lid (24, 34) is connected to or made as a part of the housing structure (20), preferably wherein the closing lid (24) is connected to or made as a part of the baseplate (2), or wherein the closing lid (24, 34) is connected to or made as a part of the of the cover (3). An embodiment of the microfluidic assembly, wherein the closing lid (24) is made as a part of the baseplate (2) is shown in FIGS. 11 and 12. An alternative embodiment of the microfluidic assembly, wherein the closing lid (34) is made as a part of the of the cover (3) is shown in FIGS. 1, 3-8.

A prototype of an exemplary embodiment of the microfluidic assembly as disclosed herein was made, wherein the housing structure (20) comprises a baseplate (2) housing a microfluidic chip (1), and a cover (3) substantially covering the baseplate (2) and partially covering the chip (1). A photograph of the prototype is shown in FIG. 9. The design of the prototype corresponds to the one schematically depicted in FIGS. 6, 8 and 10 (upper pane). The channels of the prototype are 0.2 mm deep and 0.34 mm wide, the longest channel is the feeder channel (32) and measures 45 mm in length. The cover (3) comprises the closing lid (34) comprising the protruding element (35) for aiding the transfer of a liquid sample from the sample well (31) into the chip (1). In the prototype shown in FIG. 9, the closing lid (34) is made as a part of the of the cover (3), in line with a model of a cover (3) schematically shown in FIG. 7. The prototype comprises a hydrophobic microporous wet-out membrane (5) for absorbing excess liquid exiting from the chip (1).

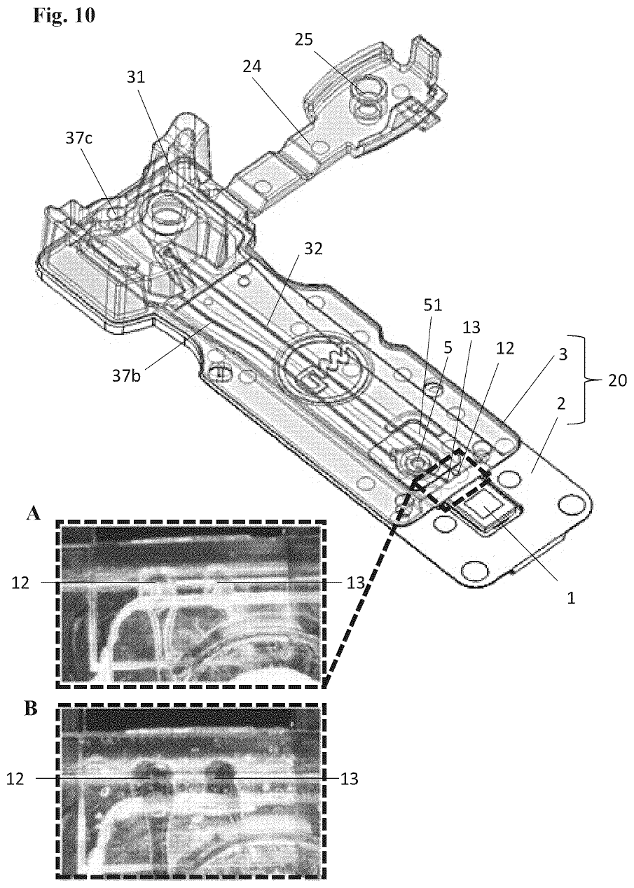

A schematic depiction of the assembled prototype from FIG. 9 is shown in the top pane of FIG. 10, wherein the cover (3) is presented as a see-through cover (3) to show the positioning of the channels. The prototype works as follows. In the first step, a sample is loaded by a user, for example by a pipette into the sample well (31). For this prototype, the preferred loading volume is set to be of about 10 ul, but volumes between 4-25 ul were successfully tested. In the prototype's the closing lid (34) the protruding part (35) is moulded with dimensions selected such with respected to the sample well (31) and the feeder channel dimensions (32) to build up the pressure in the sample well (31) and upon closing thereof, to push the sample through the opening (31a) of the sample well (31) and then through the feeder channel (32) and the first outlet port (33) into the inlet (12) of the meandering groove (11) of the chip (1). Following the successful jump into the chip (1), the sample fills the meandering groove (11) in and exits via the second outlet port (13) from the chip (1) into the membrane chamber (36). As the sample exits, it meets the hydrophobic wet-out membrane (5), wherein it is stopped but any air originating from the above-explained fluidic path can continue and is pushed back through the venting channel (37b) towards the exit from the prototype through the outlet vent (37c), present next to the sample well (31).

A series of tests was performed with various users loading 10 ul of a liquid sample stained with a dark blue dye (Coomassie brilliant blue) into the sample well (31) of the prototype shown in FIG. 9. Pictures of the chip (1) were taken before and after loading the dark-coloured liquid sample into the prototype, with or without closing of the closing lid (34). Only in the group wherein the closing lid (34) with the protruding part (35) was closed by a user following the loading of the sample into the sample well (31), the blue colour of the sample was observed inside the chip (1) as depicted in bottom pane, panel B in FIG. 10, showing dark-stained conduits within the zone of the chip (1) (zone indicated by a dashed frame in the top pane of FIG. 10) comprising the inlet (12) into the groove of the chip (1) and the second outlet port (13). In the prototypes loaded without subsequent closing of the closing lid (34), the results were variable, ranging from an apparent lack of the dark-stained liquid even in the inlet (12) section, as shown in bottom pane, panel A in FIG. 10, to variable amounts of the dark-stained liquid observable in the inlet (12) section but not in the section of the second outlet port (13). The results demonstrate effective pushing of the sample liquid down the feeder channel (32) and into the chip (1) as a result of the pressure build up caused by closing of the closing lid (34) with the protruding part (35) but not without said closing.

In summary, the inventors have created a microfluidic assembly of the present disclosure, which demonstrates at least the following advantages:
Easier handling of the microfluidic assembly and more accurate sample loading into the chip (1) by the user;
Reduced sample splashing in the vicinity of the chip (1) when loading the sample liquid, and accordingly, less contamination of the chip reader; and
Improved and more reliable transfer of the sample liquid from the feeder channel (32) into the continuous groove (11) of the silicon chip (1).

When the housing structure is constructed as a multi-part assembly comprising a baseplate, a cover, and preferably a channel-shielding element, said baseplate, cover and channel-shielding element should be aligned upon assembly. To this end, the baseplate, cover and the additional channel-shielding element when present comprise at least one, preferably two or more alignment guiding elements such as pinholes and/or dents.

In a second aspect of the invention, a kit of parts is provided for assembling the microfluidic assembly of the invention comprising a baseplate (2), a cover (3), and optionally a channel-shielding element (4) and, alternatively further the chip (1).

In a third aspect of the invention, last but not least, the resent disclosure also provides a use of the microfluidic assembly for performing a diagnostic test.

1. A microfluidic assembly for performing a diagnostic test, the assembly comprising:
a silicon chip comprising a continuous groove;
a housing structure for housing the silicon chip;
a sample well for receiving liquid;
a first outlet port at the housing structure adapted to guide the liquid to the continuous groove of the silicon chip;
a feeder channel extending from the sample well to the first outlet port; and
a closing lid comprising a protruding part adapted to close the sample well,
wherein a volume of the protruding part is adapted to a volume of the feeder channel such that when closing the sample well after providing the liquid thereto, a driving pressure is created that is sufficient to provide an additional push for assisting the liquid present in the feeder channel to pass from the first outlet port to the continuous groove of the silicon chip, thereby initialling a jump of a least a portion of the liquid into the continuous groove, which allows to fill said groove with the liquid.

2. A microfluidic assembly according to claim 1, wherein the distance between the sample well and the first outlet port is at least 0.5 cm.

3. A microfluidic assembly according to claim 1, wherein the housing structure further comprises:
a baseplate for supporting the silicon chip, and
a cover.

4. A microfluidic assembly according to claim 3, wherein at least part of the feeder channel is formed as a recess present in the baseplate, the cover, or the baseplate and the cover.

5. A microfluidic assembly according to claim 3, further comprising a channel-shielding element attached to the housing structure, the channel-shielding element being positioned between the baseplate and the cover.

6. A microfluidic assembly according to claim 5, wherein at least part of the feeder channel is formed between the recess and the channel-shielding element.

7. A microfluidic assembly according to claim 5, wherein a width of the feeder channel is adapted to decrease towards the first outlet port such that overflowing towards the continuous groove during filling is prevented.

8. A microfluidic assembly according to claim 5, wherein the assembly is predominantly beam-shaped, and the feeder channel is positioned lengthwise along the assembly.

9. A microfluidic assembly according to claim 5, further comprising a second outlet port at an end of the continuous groove adapted to vent the continuous groove of the silicon chip.

10. A microfluidic assembly according to claim 9, wherein the housing structure further comprises a membrane chamber fluidically connected with or adapted to cover the second outlet port, the membrane chamber comprising a hydrophobic membrane adapted for blocking a passage of liquid while allowing airflow.

11. A microfluidic assembly according to claim 10, wherein the membrane chamber further comprises a vent channel opening adapted for venting, the vent channel opening being fluidically connected with a vent channel that ends with an outlet vent.

12. A microfluidic assembly according to claim 10, wherein the housing structure further comprises a connection channel adapted to connect the membrane chamber to the continuous.

13. A microfluidic assembly according to claim 10, wherein the housing structure further comprises an outlet vent and a vent channel.

14. A kit of parts for assembling the microfluidic assembly according to claim 3 comprising a baseplate, a cover, and a channel-shielding element.

15. Use of the microfluidic assembly according to claim 1 for performing a diagnostic test.

16. A microfluidic assembly according to claim 3, wherein at least part of the feeder channel is formed as a recess present in the cover.

17. A microfluidic assembly according to claim 3, wherein the feeder channel is formed as a recess present in the cover.

18. A microfluidic assembly according to claim 1, wherein the distance between the sample well and the first outlet port is at least 2 cm.
